(19) United States
(12) Patent Application Publication
(10) Pub. No.: US 2026/0106531 A1
(43) Pub. Date: Apr. 16, 2026

(54) CHARGE INTEGRATED CIRCUIT AND ELECTRONIC DEVICE COMPRISING THE SAME

(71) Applicant: Samsung Electronics Co., Ltd., Suwon-si (KR)

(72) Inventors: Sungwoo LEE, Suwon-si (KR); Sungwoo MOON, Suwon-si (KR); Hyoungseok OH, Suwon-si (KR); Daewoong CHO, Suwon-si (KR)

(73) Assignee: Samsung Electronics Co., Ltd., Suwon-si (KR)

(21) Appl. No.: 19/340,285

(22) Filed: Sep. 25, 2025

(30) Foreign Application Priority Data
Oct. 11, 2024 (KR) 10-2024-0138852
Jan. 15, 2025 (KR) 10-2025-0006358

(51) Int. Cl. H02M 1/00; H02M 3/155

(52) U.S. Cl. CPC H02M 1/0048; H02M 3/155

(57) ABSTRACT

Provided is a charge integrated circuit including a switching circuit including a path transistor between a first node and a second node, the first node configured to receive an input voltage, a first transistor between the second node and a third node, a second transistor between the second node and a fourth node, a third transistor between the second node and a fifth node, a fourth transistor between the third node and a ground voltage, a fifth transistor between the fourth node and the ground voltage, and a sixth transistor between the fifth node and the ground voltage, a plurality of inductors connected to the switching circuit, and a charge transistor between at least one inductor of the plurality of inductors and a battery node; and a charging controller configured to generate a driving control signal, the driving control signal configured to control the switching circuit.

### CROSS-REFERENCE TO RELATED APPLICATION

This application claims priority to and the benefit of Korean Patent Application No. 10-2024-0138852 filed with the Korean Intellectual Property Office on Oct. 11, 2024, and Korean Patent Application No. 10-2025-0006358 filed with the Korean Intellectual Property Office on Jan. 15, 2025, the entire contents of which are incorporated herein by reference.

### BACKGROUND

Various example embodiments of inventive concepts relate to a charge integrated circuit and an electronic device including the same.

An electronic device may include a power supply configured to convert a voltage input from an external source to supply a power voltage to internal components, or to convert a voltage input from a built-in battery to supply a voltage to an external device. The power supply includes a voltage converter, and in particular, a DC-DC converter having a relatively small size and high efficiency for efficiently supplying a stable power voltage.

As the power consumption of electronic devices has increased in recent years, battery capacity has increased, and as a result, batteries may be charged under various voltage conditions, such as fast charging or normal charging. However, during the charging process, power loss may occur due to resistive components, and thus, a charge integrated circuit (IC) and an electronic device capable of addressing this issue (e.g., the power loss) may be beneficial for improving the technical field of electronic devices including charge integrated circuits (ICs).

### SUMMARY

Various example embodiments of inventive concepts provide a charge integrated circuit (IC) configured to reduce a power loss caused by resistive components.

Various example embodiments provide a charge integrated circuit including a switching circuit, the switching circuit including a path transistor between a first node and a second node, the first node configured to receive an input voltage, a first transistor between the second node and a third node, a second transistor between the second node and a fourth node, a third transistor between the second node and a fifth node, a fourth transistor between the third node and a ground voltage, a fifth transistor between the fourth node and the ground voltage, and a sixth transistor between the fifth node and the ground voltage, a plurality of inductors connected to the switching circuit, and a charge transistor connected between at least one inductor of the plurality of inductors and a battery node; and a charging controller configured to generate a driving control signal, the driving control signal configured to control the switching circuit.

Various example embodiments provide an electronic device including a switching converter, the switching converter including a path transistor between a first node and a second node, the first node configured to receive an input voltage, a switching circuit including a plurality of transistor pairs between the second node and a ground voltage, a plurality of inductors connected to the switching circuit and grouped into a first group and a second group, and a charge transistor between a first inductor of the plurality of inductors included in the first group and a battery node, wherein a second inductor of the plurality of inductors included in the second group is between the switching circuit and the battery node, a charging controller configured to generate a driving control signal, the driving control signal configured to control the switching circuit, a battery connected to the battery node, and a power management integrated circuit (PMIC) connected to a charging node between an inductor of the plurality of inductors included in the first group and the charge transistor.

Various example embodiments of inventive concepts provide a charge integrated circuit (IC) including a path transistor between a first node and a second node, the first node configured to receive an input voltage, a first transistor between the second node and a third node, a second transistor between the second node and a fourth node, a third transistor between the second node and a fifth node, a fourth transistor between the third node and a ground voltage, a fifth transistor between the fourth node and the ground voltage, a sixth transistor between the fifth node and the ground voltage, a charge transistor between the third node and a battery node, a first inductor between the third node and the charge transistor, a second inductor between the fourth node and the battery node, and a third inductor between the fifth node and the battery node.

Various example embodiments of inventive concepts provide an electronic device including an image processing circuitry including an image sensor, a communication circuitry including an antenna, an audio processing circuitry including at least one of a microphone or a speaker, a buffer memory configured to store data used for one or more operations of the electronic device, a user interface including an input interface and an output interface, one or more processors configured to control the one or more operations of the electronic device, a battery configured to supply power to the electronic device, a power management circuit configured to manage the supply of the power, and a charge integrated circuit (IC) configured to perform at least one of charging the battery based on power supplied from an external power source or supplying the power supplied from the battery to the power management circuit.

In some example embodiments, the charge integrated circuit (IC) includes a switching converter including a switching circuit, a plurality of inductors connected to the switching circuit, a charge transistor between at least one inductor of the plurality of inductors and a battery node, and a charging controller configured to generate a driving control signal, the driving control signal configured to control the switching circuit.

In some example embodiments, the switching circuit includes a path transistor between a first node and a second node, the first node configured to receive an input voltage, a first transistor between the second node and a third node, a second transistor between the second node and a fourth node, a third transistor between the second node and a fifth node, a fourth transistor between the third node and a ground voltage, a fifth transistor between the fourth node and the ground voltage, and a sixth transistor between the fifth node and the ground voltage.

### BRIEF DESCRIPTION OF THE DRAWINGS

FIG. 1 is a block diagram illustrating an electronic device including a charge integrated circuit according to some example embodiments.

FIG. 2 is a block diagram illustrating a power supply device according to some example embodiments.

FIG. 3 is a diagram illustrating a switching converter according to some example embodiments.

FIG. 4 is a diagram illustrating the flow of current when the switching converter according to FIG. 3 operates in buck mode.

FIG. 5 is a diagram illustrating the flow of current when the switching converter according to FIG. 3 operates in load boosting mode.

FIG. 6 is a block diagram illustrating a power supply device according to some example embodiments.

FIG. 7 is a diagram illustrating a switching converter according to some example embodiments.

FIG. 8 is a block diagram illustrating an electronic device including a charge integrated circuit according to some example embodiments.

FIG. 9 is a block diagram illustrating an electronic device including a charge integrated circuit according to some example embodiments.

### DETAILED DESCRIPTION

In the following detailed description, some example embodiments of the present inventive concepts have been shown and described, simply by way of illustration. As those skilled in the art would realize, the described example embodiments may be modified in various different ways, all without departing from the spirit or scope of the present inventive concepts. Accordingly, the drawings and description are to be regarded as illustrative in nature and not restrictive. Like reference numerals designate like elements throughout the specification. In the flowchart described with reference to the drawing, an operation order may be changed, several operations may be merged, or some operation may be divided, or a specific operation may not be performed. Further, expression described as a singular form may be interpreted as singular or plural unless explicit expression such as “one” or “single” is used. Terms including an ordinary number, such as first and second, are used for describing various constituent elements, but the constituent elements are not limited by the terms. The terms are used only to discriminate one constituent element from another constituent element.

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to the other elements and/or properties thereof. Elements and/or properties thereof that are “the same” or “equal” to other elements and/or properties thereof will be understood to include elements and/or properties thereof that are identical to, the same as, or equal to the other elements and/or properties thereof within manufacturing tolerances and/or material tolerances (e.g., ±10%). Elements and/or properties thereof that are identical, the same, and/or equal as other elements and/or properties thereof may be structurally the same or substantially the same, functionally the same or substantially the same, and/or compositionally the same or substantially the same thereof.

It will be understood that elements and/or properties thereof (e.g., structures, surfaces, directions, or the like), which may be referred to as being “perpendicular,” “parallel,” “coplanar,” or the like with regard to other elements and/or properties thereof (e.g., structures, surfaces, directions, or the like) may be “perpendicular,” “parallel,” “coplanar,” or the like or may be “substantially perpendicular,” “substantially parallel,” “substantially coplanar,” respectively, with regard to the other elements and/or properties thereof.

Elements and/or properties thereof (e.g., structures, surfaces, directions, or the like) that are “substantially parallel” with regard to other elements and/or properties thereof will be understood to be “parallel” with regard to the other elements and/or properties thereof within manufacturing tolerances and/or material tolerances and/or have a deviation in magnitude and/or angle from “parallel,” or the like with regard to the other elements and/or properties thereof that is equal to or less than 10% (e.g., a. tolerance of ±10%).

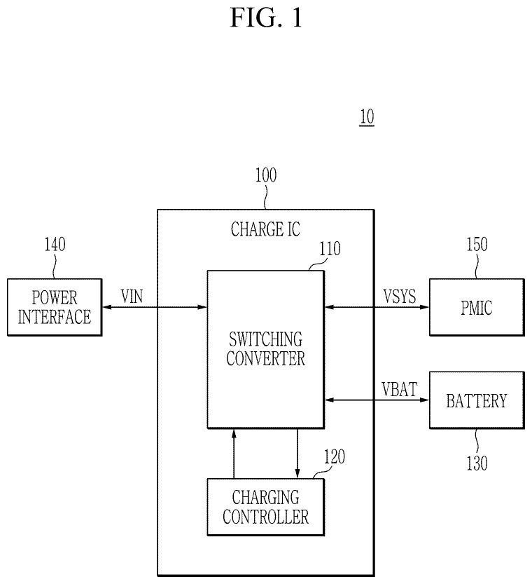

FIG. 1 is a block diagram illustrating an electronic device including a charge integrated circuit according to some example embodiments.

Referring to FIG. 1, an electronic device 10 may include a charge integrated circuit (IC) 100, a battery 130, a power interface 140, and a power management integrated circuit (PMIC) 150. Although not shown in FIG. 1, the electronic device 10 may further include a main processor (or one or more processors) and peripheral devices, but example embodiments are not limited thereto.

For example, the electronic device 10 may be a mobile device such as a smart phone, a tablet PC (Personal Computer), a mobile phone, a PDA (Personal Digital Assistant), a laptop, a wearable device, a GPS (Global Positional System) device, an e-book reader, a digital broadcasting terminal, an MP3 player, a digital camera, etc. For example, the electronic device 10 may be an electric vehicle.

The battery 130 may be included in the electronic device 10 (e.g., may be built into the electronic device 10). In some example embodiments, the battery 130 may be detachable from the electronic device 10. The battery 130 may include one or more battery cells. A plurality of battery cells may be connected in series or parallel (or in a combination of series and parallel). In some example embodiments, when no external charging device is connected to the electronic device 10, the battery 130 may supply power to the electronic device 10.

The charge IC 100 may be connected to a PMIC 150. The charge IC 100 may be connected to a PMIC 150 to form (or provide) a charge path for charging a battery 130. The charge IC 100 may form (or provide) a charge path for charging an external device.

In some example embodiments, the charge IC 100 may charge a battery 130 and may be referred to as a “battery charger.”Additionally or alternatively, the charge IC 100 may supply power to an external device connected to the charge IC 100 based on the voltage charged to the battery 130. For example, the charge IC 100 may be implemented as one or more integrated circuit chips and may be mounted on a printed circuit board.

The charge IC 100 may include a switching converter 110 and a charging controller 120.

In some example embodiments, the charge IC 100 may include an undervoltage lockout (UVLO) function, an overcurrent protection (OCP) function, an overvoltage protection (OVP) function, an internal soft-start function to reduce inrush current, a foldback current limit function, a hiccup mode function for short circuit protection, and an overtemperature protection (OTP) function to operate under power saving conditions (or to operate appropriately under power saving conditions).

A switching converter 110 may convert an input voltage and output it (e.g., the converted input voltage) to a load. For example, a switching converter 110 may receive an input voltage VIN and output a converted voltage VBAT to a battery 130 through a switching operation. The switching converter 110 may boost the voltage VBAT of the battery 130 to provide an output voltage VSYS to the PMIC 150. The switching converter 110 may be at least one buck converter that generates a target output voltage VBAT lower than the input voltage VIN, or the switching converter 110 may be at least one boost converter that generates a target output voltage VBAT higher than the input voltage VIN. For example, the switching converter 110 may perform a buck converting operation that generates a target output voltage VBAT by stepping down the input voltage VIN, a boost converting operation, or a load boosting operation that generates a target output voltage VSYS by stepping up the input voltage VBAT. For example, the switching converter 110 may perform a load boosting operation when (or in response to) the remaining charge capacity of the battery 130 is below a predetermined level (or a desired level, or a particular level).

For example, the switching converter 110 may supply a target output voltage VSYS to the PMIC 150 based on the input voltage VIN received through the power interface 140. Hereinafter, the target output voltage VSYS may be the system voltage. In some example embodiments, if the target output voltage VSYS set for the PMIC 150 is smaller than the input voltage VIN, the charge IC 100 may control the switching converter 110 to supply the target output voltage VSYS based on the voltage VBAT of the battery 130. For example, the target output voltage VSYS may be supplied in a constant manner. In some example embodiments, if the target output voltage VSYS set for the PMIC 150 is greater than the input voltage VIN, the charge IC 100 may provide the target output voltage VSYS to the PMIC 150 and then supply power to the battery 130.

A target output voltage VBAT may be supplied to the battery 130, and a target output voltage VSYS may be supplied to the PMIC 150 based on the voltage VBAT received from the battery 130. Accordingly, the switching converter 110 may supply a target output voltage VSYS in a constant manner.

The switching converter 110 may be a switching mode power supply (SMPS) or a power converter.

In some example embodiments, the switching converter 110 may be a multi-level DC-DC converter including a plurality of transistors and a plurality of inductors. For example, the switching converter 110 may be a 2-level DC-DC converter, but example embodiments are not limited thereto. In some example embodiments, 2-level DC-DC converter refers to the number of voltage levels used for switching operation. A 2-level DC-DC converter may output an input voltage and a ground voltage (e.g., 0 V) as an output voltage.

The charging controller 120 may control mode switching between multiple switching modes of the switching converter 110, such as buck mode, boost mode, and load boosting mode. Additionally or alternatively, the charging controller 120 may control the switching operation of the switching converter 110 according to the switching mode. In some example embodiments, the charging controller 120 may generate a driving control signal CS to control the switching operation in each switching mode of the switching converter 110. For example, the charging controller 120 may generate a plurality of PWM (Pulse Width Modulation) signals based on a plurality of signals received from the switching converter 110, and may generate a driving control signal CS that may control the switching operation of a plurality of transistors based on the plurality of PWM signals. In some example embodiments, the charging controller 120 may generate a driving control signal CS based on several control factors such as the output voltage of the switching converter 110, input voltage, output current, input current, current flowing into the battery 130, and voltage of the battery 130.

The switching converter 110 may operate in one of the buck mode, boost mode, and load boosting mode based on the control of the charging controller 120.

The switching converter 110 may perform a buck converting operation or a boost converting operation based on the amount of power supplied from or to a connected external device.

For example, when the driving control signal CS is at a first level, the switching converter 110 may operate in buck mode. The switching converter 110 may step down the input voltage by performing a buck converting operation and charge the battery 130 based on the stepped down voltage.

For example, when the driving control signal CS is at the second level, the switching converter 110 may operate in boost mode. The switching converter 110 may step up the voltage input from the battery 130 by performing a boost converting operation and supply power to an external device based on the stepped-up voltage.

For example, when the driving control signal CS is at the third level, the switching converter 110 may operate in load boosting mode. The switching converter 110 may step up the voltage input from the battery 130, step down the voltage of the boosted first connection node, and supply power to the PMIC 150 through the load node based on the stepped-down voltage.

A PMIC 150 may be a circuit that performs electronic power conversion or power control functions. In some example embodiments, the PMIC 150 may be connected to a switching converter 110 and may receive power from the switching converter 110. The PMIC 150 may convert, rectify, distribute, and control the voltage or current used (or required) by the electronic device 10 based on the supplied power.

In some example embodiments, the electronic device 10 may support wired charging and wireless charging, and may include a power interface 140 including a wired power interface and a wireless power interface for wired charging and wireless charging. For example, a wired power interface may include wired charging circuit, and a wireless power interface may include wireless charging circuit. The wired charging circuit and the wireless charging circuit may include a rectifier, a regulator, and the like.

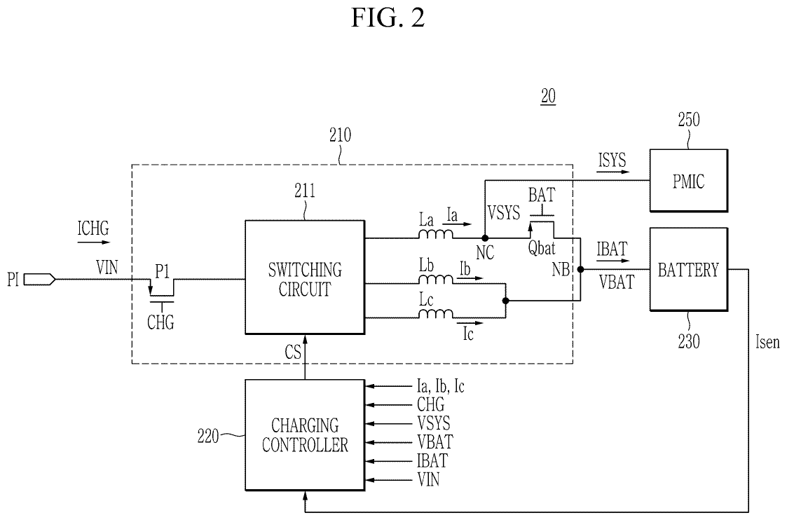

FIG. 2 is a block diagram illustrating a power supply device according to some example embodiments.

Referring to FIG. 2, a power supply device 20 may be connected between an input/output pin PI and a battery 230. The power supply device 20 may convert the input voltage VIN provided to the input/output pin PI and provide it to the battery 230. The power supply device 20 may output an output voltage VOUT converted from a voltage from a battery 230 to an input/output pin PI. The power supply device 20 may include a switching converter 210 and a charging controller 220.

A switching converter 210 may include a path transistor P1, a switching circuit 211, and at least one inductor La, Lb, Lc. The path transistor P1 is connected between the input/output pin PI and the switching circuit 211 and may operate based on a control signal CHG provided from the outside (e.g., from an external device). Meanwhile, in FIG. 2, the path transistor P1 is illustrated as one transistor connected between the input/output pin PI and the switching circuit 211, but example embodiments are not limited thereto. For example, the path transistor P1 may include two or more transistors connected in a back-to-back manner.

The switching circuit 211 may store energy by the input voltage VIN in at least one inductor La, Lb, Lc or release energy stored in at least one inductor La, Lb, Lc in response to a driving control signal CS controlled by the charging controller 220.

For example, the switching circuit 211 may store energy in the first inductor La as a current flows through the first inductor La by the input voltage VIN (e.g., by receiving the input voltage VIN). For example, the switching circuit 211 may store energy in the first inductor La, the second inductor Lb, and the third inductor Lc as a current flows through the first inductor La, the second inductor Lb, and the third inductor Lc by the input voltage VIN (e.g., caused by receiving the input voltage VIN). For example, the switching circuit 211 may release energy stored in the first inductor La, the second inductor Lb, and the third inductor Lc. The energy released from the first inductor La, the second inductor Lb, and the third inductor Lc may be supplied to the load as current.

The switching circuit 211 may transmit the system voltage VSYS of the charging node NC to the PMIC 250 through the first inductor La.

The switching circuit 211 may transfer the battery voltage VBAT of the battery node NB to the battery 230 through the second inductor Lb and the third inductor Lc. The battery voltage VBAT may be the target output voltage of the power supply device 20.

The charge transistor Qbat may transmit the system voltage VSYS of the charging node NC to the PMIC 250 in response to the control signal BAT. The system voltage VSYS may be the target output voltage of the power supply device 20. In some example embodiments, the charge transistor Qbat may be turned off when overcurrent occurs (or in response to an overcurrent). For example, the PMIC 250 of FIG. 2 may be connected to the switching converter 210, and when (or in response to) the current flowing from the switching converter 210 to the PMIC 250 of FIG. 2 is greater than the threshold current, the charge transistor Qbat may be turned off.

The charging controller 220 may generate a driving control signal CS that controls the switching circuit 211 based on control factors such as currents Ia, Ib, Ic flowing through the plurality of inductors, input current ICHG, system voltage VSYS, system current ISYS, battery voltage VBAT, battery current IBAT, input voltage VIN, and temperature information.

In some example embodiments, the charging controller 220 may control the input current ICHG so that it does not exceed a predetermined value (or a particular value, or a desired value). The charging controller 220 may control the inductor currents Ib and Ic to compensate for the system current ISYS when (or in response to) the each of the currents Ia, Ib, Ic flowing through the plurality of inductors has the same value, and when the inductor current Ia is smaller than the system current ISYS.

In some example embodiments, the charging controller 220 may control the switching converter 210 to input a system current ISYS corresponding to the PMIC 250 to the PMIC 250. For example, the system current ISYS may be a predetermined current corresponding to the PMIC 250 (or the system current ISYS may be a particular or desired current corresponding to the PMIC 250). In some example embodiments, when the magnitude of the input current ICHG is smaller than the magnitude used (or required) to provide the system current ISYS (or the predetermined system current ISYS), the charging controller 220 may control the switching converter 210 to compensate the system current ISYS based on the current flowing in the charge transistor Qbat among the battery current IBAT. At this time, the charging controller 220 may control the switching converter 210 so that current does not flow through the plurality of inductors Lb, Lc. In some example embodiments, when the magnitude of the input current ICHG is greater than the magnitude used (or required) to provide the system current ISYS (or the predetermined system current ISYS), the charging controller 220 may control the switching converter 210 to provide the system current ISYS and charge the battery 230 based on the remaining current.

The charging controller 220 may adjust the period and duty cycle of the driving control signal CS under light load conditions. For example, the driving control signal CS may be a PWM signal. For example, the charging controller 220 may generate a driving control signal CS so that the switching converter 210 performs a buck converting operation, a boost converting operation, or a load boosting operation based on a first level driving control signal CS, a second level driving control signal CS, and a third level driving control signal CS. In some example embodiments, the charging controller 120 may control currents Ia, Ib, Ic flowing through a plurality of inductors based on a driving control signal CS.

In some example embodiments, when the switching converter 210 operates in buck mode, a first path (or first power path, hereinafter referred to as the first path) may be formed (or provided) in which power is supplied to the battery 230 through a plurality of inductors La, Lb, Lc from at least one external device connected through a power interface (e.g., the power interface 140 in FIG. 1). The first path may include a first sub-path in which power is supplied to the battery 230 through one inductor (e.g., La) of the plurality of inductors and a second sub-path in which power is supplied to the battery 230 through another inductor Lb, Lc of the plurality of inductors. The switching converter 210 charges the battery 230 through the first sub-path and the second sub-path, so that the charging speed of the battery 230 may increase. In some example embodiments, in a first path through which power is supplied to the battery 230, the first sub-path passes through the charge transistor Qbat, while a second sub-path does not pass through the charge transistor Qbat. Accordingly, power loss caused by the resistance component of the charge transistor Qbat may be reduced, compared to a case where the battery is charged through a single path passing through the charge transistor Qbat.

In some example embodiments, when the switching converter 110 operates in boost mode, a charge path may be formed (or provided) in which power is supplied from the battery 230 to the PMIC 250.

In some example embodiments, when the switching converter 110 operates in a load boosting mode, a second path in which power is supplied from the battery 230 to the first connection node through a plurality of inductors Lb, Lc and a third path in which power is supplied from the first connection node to the charging node NC may be formed (or provided). For example, when the voltage of the battery 230 is lower than the threshold voltage while no external device is connected through the power interface (e.g., the power interface 140 in FIG. 1), the switching converter 110 may not supply power to the PMIC 250 through the battery 230. To prevent this (or to reduce a likelihood of the switching converter 110 not supplying power to the PMIC 250 through the battery 230), when the voltage of the battery 230 is lower than the threshold voltage, the switching converter 110 may step up the voltage of the first connection node through the second path, and may step down the voltage of the load node through the third path through which power is supplied from the first connection node to the load node. Accordingly, even if the remaining charge capacity of the battery 230 is below a predetermined (or a particular, or a desired) level, the electronic device 10 is not turned off and the switching converter 110 may supply power to the PMIC 250 in a constant manner.

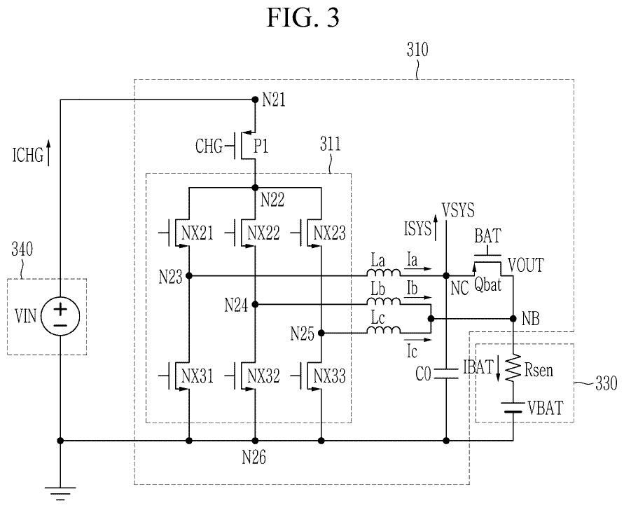

FIG. 3 is a diagram illustrating a switching converter according to some example embodiments.

As illustrated in FIG. 3, the switching converter 310 may be connected to a power interface 340 and a battery 330. A switching converter 310 may include a switching circuit 311, a path transistor P1, a charge transistor Qbat, a plurality of inductors La, Lb, Lc, and a capacitor C0.

A power interface 340 may be connected between the first node N21 and the sixth node N26. The sixth node N26 may be connected to ground voltage.

The switching circuit 311 is connected between one end of the path transistor P1 and the sixth node N26 and may include a plurality of transistor pairs NX21-NX31, NX22-NX32, NX23-NX33. The switching circuit 311 may include a first transistor NX21, a second transistor NX22, a third transistor NX23, a fourth transistor NX31, a fifth transistor NX32, and a sixth transistor NX33.

In some example embodiments, a path transistor P1 may be connected between a first node N21 and a second node N22 (a first connection node). A first transistor NX21 may be connected between a second node N22 and a third node N23, a second transistor NX22 may be connected between a second node N22 and a fourth node N24, and a third transistor NX23 may be connected between a second node N22 and a fifth node N25. The fourth transistor NX31 may be connected between the third node N23 and the sixth node N26, the fifth transistor NX32 may be connected between the fourth node N24 and the sixth node N26, and the sixth transistor NX33 may be connected between the fifth node N25 and the sixth node N26.

In some example embodiments, each of the plurality of transistors NX21, NX31, NX22, NX32, NX23, NX33 may be an N-channel Metal Oxide Semiconductor (NMOS) or a P-channel Metal Oxide Semiconductor (PMOS), but example embodiments are not limited thereto.

The plurality of inductors La, Lb, Lc may include a first inductor La, a second inductor Lb, and a third inductor Lc. In some example embodiments, the first inductor La may be connected between the third node N23 and the charging node NC, the second inductor Lb may be connected between the fourth node N24 and the battery node NB, and the third inductor Lc may be connected between the fifth node N25 and the battery node NB.

A capacitor C0 may be connected between the charging node NC and the sixth node N26. The capacitor C0 may charge the voltage of the charging node NC and discharge the charged voltage through the connection terminal of the PMIC (e.g., the PMIC 250 in FIG. 2). The switching circuit 311 may charge by converting a first-level input voltage VIN into a third-level voltage VSYS, or may discharge by converting the third-level voltage VSYS into the first-level input voltage VIN.

A charge transistor Qbat may be connected between a charging node NC and a battery node NB. In some example embodiments, the charge transistor Qbat may be turned off when (or in response to) an overcurrent flows from the battery node NB to the charging node NC.

The battery 330 may include a battery resistance Rsen and a battery voltage VBAT. Battery current IBAT may flow through the battery 330.

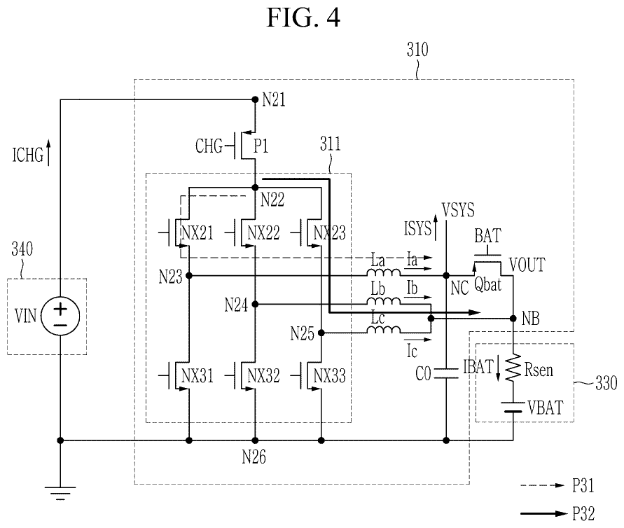

FIG. 4 is a diagram illustrating the flow of current when the switching converter according to FIG. 3 operates in buck mode.

In some example embodiments, when the switching converter 310 performs a buck converting operation, a first path may be formed (or provided) in which power is supplied to the battery 330 through a plurality of inductors La, Lb, Lc from at least one external device connected through the power interface 340.

The first path may include a first sub-path P31 in which power is supplied to a battery 330 through a first inductor La and a second sub-path P32 in which power is supplied to the battery 330 through a second inductor Lb.

For example, the switching converter 310 may receive a first driving control signal CS from the charging controller 120 of FIG. 1. Based on the first driving control signal CS, the path transistor P1 and a plurality of transistor pairs NX21-NX31, NX22-NX32, NX23-NX33 may perform switching operations. During a specific period, the path transistor P1 and the charge transistor Qbat may be turned on. During some periods of a specific period, the first transistor NX21, the second transistor NX22, and the third transistor NX23 may be turned on, and the fourth transistor NX31, the fifth transistor NX32, and the sixth transistor NX33 may be turned off. During some periods of a specific period, the fourth transistor NX31, the fifth transistor NX32, and the sixth transistor NX33 may be turned on, and the first transistor NX21, the second transistor NX22, and the third transistor NX23 may be turned off. A first sub-path P31 may be formed by the switching operations of the first transistor NX21 and the fourth transistor NX31, and a second sub-path P32 may be formed by the switching operations of the second transistor NX22, the third transistor NX23, the fifth transistor NX32, and the sixth transistor NX33. The switching converter 310 charges the battery 330 through the first sub-path P31 and the second sub-path P32, so that the charging speed of the battery 330 may increase.

In some example embodiments, when the charge transistor Qbat is connected between the charging node NC and the battery node NB, the first sub-path P31 through which power is supplied to the battery 330 passes through the charge transistor Qbat, while the second sub-path P32 does not pass through the charge transistor Qbat. In some example embodiments, when charging a battery 330 with an inductor Lb, Lc, power loss due to the resistance component of the charge transistor Qbat may be reduced because the charging path does not pass through the charge transistor Qbat, compared to a case where a plurality of inductors La, Lb, Lc are all connected to the charge transistor Qbat.

In FIG. 3, the switching circuit 311 in the switching converter 310 is illustrated as including six transistors NX21, NX22, NX23, NX31, NX32, NX33 and the switching converter 310 as including three inductors La, Lb, Lc, but example embodiments are not limited thereto, and the switching circuit 311 may include six or more transistors and the switching converter 310 may include three or more inductors.

A capacitor C0 may be connected to a charging node NC. In some example embodiments, when the switching converter 310 operates in buck mode, the square wave output voltage output to the charging node NC may be rectified into a DC voltage.

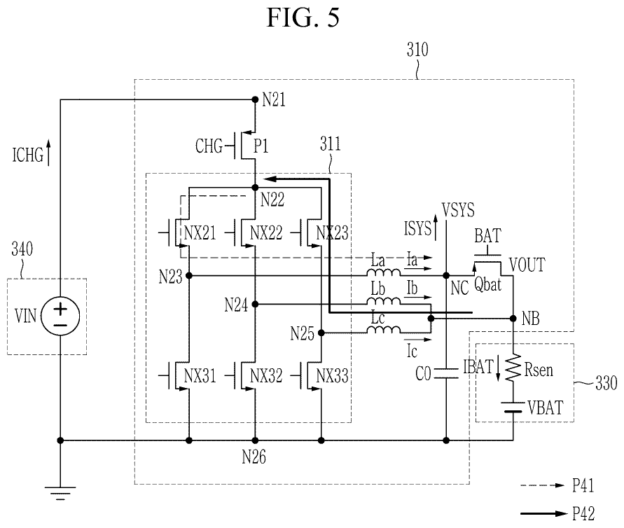

FIG. 5 is a diagram illustrating the flow of current when the switching converter according to FIG. 3 operates in load boosting mode.

In some example embodiments, when the switching converter 310 performs a boosting operation, a charge path may be formed in which power is supplied from the battery 330 to the PMIC (e.g., the PMIC 250 in FIG. 2). For example, the PMIC 250 may be connected to a charging node NC and may receive power from a switching converter 310 through the charging node NC.

In some example embodiments, when the remaining charge capacity of the battery 330 (e.g., the voltage of the battery node NB) is below a predetermined (or a particular, or a desired) level, the switching converter 310 may perform a load boosting operation. For example, when the remaining charge capacity of the battery 330 is below a predetermined (or a particular, or a desired) level (for example, when the voltage of the battery 330 is below a threshold voltage) while no external device is connected via the power interface (e.g., the power interface 140 of FIG. 1), the switching converter 310 may not supply power to the PMIC 250 through the battery 330, and the power of the electronic device 10 of FIG. 1 may be turned off. To prevent this (or to reduce a likelihood of the power of the electronic device 10 of FIG. 10 being turned off), when the voltage of the battery 330 is lower than the threshold voltage, the switching converter 310 may perform a load boosting operation.

In some example embodiments, when the switching converter 310 performs a load boosting operation, a second path P42 and a third path P41 may be formed (or provided). The second path P42 may be a path that steps up the voltage of the second node N22 from the battery 230 through a plurality of inductors Lb, Lc. The third path P41 may be a path in which power is supplied from the second node N22 to the charging node NC through the inductor La.

The switching converter 310 may step up the voltage input from the battery 330 through the second path P42. The switching converter 310 may perform a boosting operation through the second path P42. The switching converter 310 may step down the voltage of the second node N22 boosted through the third path P41 and supply power to the PMIC 250 based on the stepped down voltage.

For example, the switching converter 310 may receive a second driving control signal CS from the charging controller 120 of FIG. 1. Based on the second driving control signal CS, the path transistor P1 and a plurality of transistor pairs NX21-NX31, NX22-NX32, NX23-NX33 may perform switching operations. The switching converter 310 may perform a load boosting operation including a third period, a fourth period, and a fifth period. In the third period, the path transistor P1 and the charge transistor Qbat may be turned off. In the fourth period, the second transistor NX22 and the third transistor NX23 may be turned on, and the first transistor NX21, the fourth transistor NX31, the fifth transistor NX32, and the sixth transistor NX33 may be turned off. The switching converter 310 may perform a boost switching operation in the fourth period. In the fifth period, the first transistor NX21 may be turned on, and the second transistor NX22, the third transistor NX23, the fourth transistor NX31, the fifth transistor NX32, and the sixth transistor NX33 may be turned off. The switching converter 310 may perform a buck switching operation in the fifth period.

A second path P42 may be formed (or provided) during the fourth period, and a third path P41 may be formed during the fifth period. Accordingly, even if the remaining charge capacity of the battery 330 is below a predetermined (or a particular, or a desired) level, the switching converter 310 may maintain the voltage VSYS of the load node at a certain level, and the electronic device may be supplied the power in a constant manner without being turned off.

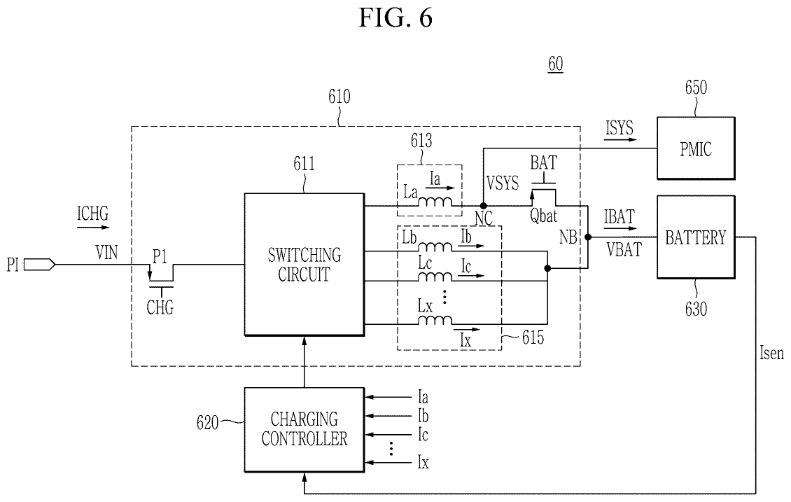

FIG. 6 is a block diagram illustrating a power supply device according to some example embodiments.

Referring to FIG. 6, a power supply device 60 may be connected between the input/output pin PI and the battery 630. The power supply device 60 may convert the input voltage VIN provided to the input/output pin PI and provide it to the battery 630. The power supply device 60 may output an output voltage VOUT converted from a voltage from a battery 630 to the input/output pin PI. The power supply device 60 may include a switching converter 610 and a charging controller 620.

A switching converter 610 may include a path transistor P1, a switching circuit 611, and at least one inductor La, Lb, Lc. The path transistor P1 is connected between the input/output pin PI and the switching circuit 611 and may operate based on a control signal CHG provided from the outside (e.g., from an external device (not shown)).

The switching circuit 611 may store energy by the input voltage VIN in at least one inductor La, Lb, Lc, . . . , Lx or release energy stored in at least one inductor La, Lb, Lc, . . . , Lx in response to a driving control signal CS controlled by the charging controller 620. At least one inductor La, Lb, Lc, . . . , Lx may be grouped into a first group 613 and a second group 615. As illustrated in FIG. 6, the inductor La included in the first group 613 is connected to the charging node NC and may be connected to the battery node NB through the charge transistor Qbat. The inductors Lb, Lc, . . . , Lx included in the second group 615 may be directly connected to the battery node NB.

For example, the switching circuit 611 may store energy in the first inductor La in the first group 613 as a current generated by (or associated with) the input voltage VIN flowing (or being applied) thorough the first inductor La. For example, the switching circuit 611 may store energy in a first inductor La in a first group 613 and at least one inductor Lb, Lc, . . . Lx in a second group 615, as a current generated by (or associated with) an input voltage VIN flowing (or being applied) through the first inductor La in the first group 613 and the at least one inductor in the second group 615. For example, the switching circuit 611 may release energy stored in at least one inductor La, Lb, Lc, . . . Lx in the first group 613 and the second group 615. The energy released from at least one inductor La, Lb, Lc, . . . , Lx may be supplied to the load as current.

The switching circuit 611 may transmit the system voltage VSYS of the charging node NC to the PMIC 650 through the inductor La included in the first group 613.

The switching circuit 611 may transfer the battery voltage VBAT of the battery node NB to the battery 630 through the inductors Lb, Lc, . . . Lx included in the second group 615. The battery voltage VBAT may be the target output voltage of the power supply device 60.

The charge transistor Qbat may transmit the system voltage VSYS of the charging node NC to the PMIC 650 in response to a control signal BAT. The system voltage VSYS may be the target output voltage of the power supply device 60. In some example embodiments, the charge transistor Qbat may be turned off when (or in response to) overcurrent occurs. For example, the PMIC 650 of FIG. 2 may be connected to the switching converter 610, and when (or in response to) the current flowing from the switching converter 610 to the PMIC 650 of FIG. 2 is greater than the threshold current, the charge transistor Qbat may be turned off.

The charging controller 620 may generate a driving control signal CS that controls the switching circuit 611 based on control factors such as currents flowing through a plurality of inductors Ia, Ib, Ic, input current ICHG, system voltage VSYS, system current ISYS, battery voltage VBAT, battery current IBAT, input voltage VIN, and temperature information.

In some example embodiments, the charging controller 620 may control the input current ICHG so that it does not exceed a predetermined (or a particular, or a desired) value. The charging controller 620 may control the operation such that each of the currents Ia, Ib, Ic, . . . Ix flowing through the plurality of inductors has the same value, and when (or in response to) the inductor current Ia flowing through the inductor La included in the first group 613 is smaller than the system current ISYS, the inductor currents Ib, Ic, . . . Ix flowing through the inductors Lb, Lc, . . . Lx included in the second group 615 compensate for the system current ISYS.

In some example embodiments, the charging controller 620 may control the switching converter 610 to input a system current ISYS corresponding to the PMIC 650 to the PMIC 650. For example, the system current ISYS may be a predetermined current corresponding to the PMIC 650 (or the system current ISYS may be a particular or desired current corresponding to the PMIC 250). In some example embodiments, when the magnitude of the input current ICHG is smaller than a magnitude required to provide a predetermined (or a particular, or a desired) system current ISYS, the charging controller 620 may control the system to compensate for the system current ISYS based on a current flowing through the charge transistor Qbat among the battery current IBAT. At this time, the charging controller 620 may control the switching converter 610 so that current does not flow through the inductors Lb, Lc, . . . Lx included in the second group 615. In some example embodiments, when the magnitude of the input current ICHG is greater than a magnitude used (or required) to provide a predetermined (or a particular, or a desired) system current ISYS, the charging controller 620 may charge the battery 630 based on a remaining current after supplying the system current ISYS.

The charging controller 620 may adjust the period and duty cycle of the driving control signal CS under light load conditions. For example, the driving control signal CS may be a PWM signal. For example, the charging controller 620 may generate a drive control signal CS such that the switching converter 610 performs a buck converting operation, a boost converting operation, or a load boosting operation based on a first PWM signal, a second PWM signal, and a third PWM signal. In some example embodiments, the charging controller 120 may control currents Ia, Ib, Ic, . . . Ix flowing through a plurality of inductors based on a driving control signal CS.

In some example embodiments, when the switching converter 610 operates in buck mode, a first path (or first power pass, hereinafter referred to as the first path) may be formed (or provided) in which power is supplied to the battery 630 through a plurality of inductors La, Lb, Lc, . . . Lx from at least one external device connected through a power interface (e.g., the power interface 140 in FIG. 1). The first path may include a first sub-path in which power is supplied to the battery 630 through one inductor (e.g., La) included in the first group 613 and a second sub-path in which power is supplied to the battery 630 through at least one inductor Lb, Lc, . . . Lx included in the second group 615. The switching converter 610 charges the battery 630 through the first sub-path and the second sub-path, so that the charging speed of the battery 630 may increase. In some example embodiments, in a first path through which power is supplied to the battery 630, the first sub-path passes through the charge transistor Qbat, while a second sub-path does not pass through the charge transistor Qbat. Accordingly, power loss caused by the resistance component of the charge transistor Qbat may be reduced, compared to a case where the battery is charged through a single path passing through the charge transistor Qbat.

In some example embodiments, when the switching converter 610 operates in boost mode, a charge path may be formed in which power is supplied from the battery 630 to the PMIC 650.

In some example embodiments, when the switching converter 610 operates in a load boosting mode, a second path in which power is supplied from the battery 630 to the first connection node through the inductors Lb, Lc, . . . Lx included in the second group 615, and a third path in which power is supplied from the first connection node to the charging node NC may be formed. For example, when the voltage of the battery 630 is lower than the threshold voltage while no external device is connected through the power interface (e.g., the power interface 140 in FIG. 1), the switching converter 610 cannot supply power to the PMIC 650 through the battery 630. To prevent this (or to reduce the likelihood of the switching converter 610 not supplying power to the PMIC 650 through the battery 630), when the voltage of the battery 630 is lower than the threshold voltage, the switching converter 610 may step up the voltage of the first connection node through the second path, and may step down the voltage of the load node through the third path through which power is supplied from the first connection node to the load node. Accordingly, even if the remaining charge capacity of the battery 630 is below a predetermined (or a particular, or a desired) level, the electronic device 10 is not turned off and the switching converter 610 may supply power to the PMIC 650 in a constant manner.

In some example embodiments, the switching converter 610 may form (or provide) a fourth path (or only a fourth path) in which power is supplied to the charging node NC through the inductor La included in the first group 613 when (or in response to) the system current ISYS exceeds a predetermined threshold (or a particular threshold, or a desired threshold).

In some example embodiments, when the system current ISYS is less than or equal to a predetermined (or a particular, or a desired) reference value, the switching converter 610 may supply power to a charging node NC through a second path in which power is supplied to a first connection node through inductors Lb, Lc, . . . Lx included in a second group 615, a third path in which power is supplied from the first connection node to the charging node NC, and a fourth path in which power is supplied to the charging node NC through an inductor La included in a first group 613.

In FIG. 6, the switching converter 610 is illustrated as including a first group 613 including one inductor La and a second group 615 including a plurality of inductors Lb, Lc, . . . Lx, but example embodiments are not limited thereto, and the switching converter 610 may include a plurality of inductors. For example, a first number of inductors among a plurality of inductors may be included in a first group, and a second number of inductors, excluding the first number of inductors among the plurality of inductors, may be included in a second group. In some example embodiments, the first number may be smaller than the second number.

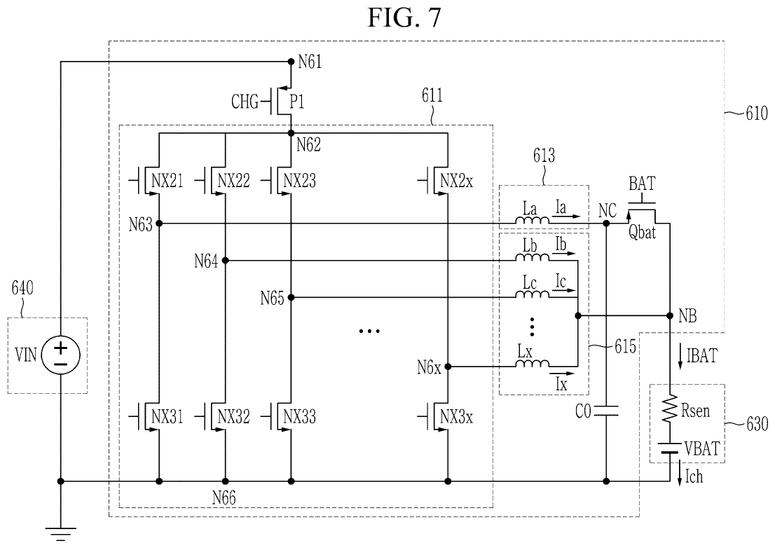

FIG. 7 is a diagram illustrating a switching converter according to some example embodiments.

As illustrated in FIG. 7, the switching converter 610 may be connected to a power interface 640 and a battery 630. The switching converter 610 may include a switching circuit 611, a path transistor P1, a charge transistor Qbat, a plurality of inductors La, Lb, Lc, . . . , Lx, and a capacitor C0.

A power interface 640 may be connected between the first node N61 and the sixth node N66. The sixth node N66 may be connected to ground voltage.

The switching circuit 611 is connected between one end of the path transistor P1 and the sixth node N66 and may include a plurality of transistor pairs NX21-NX31, NX22-NX32, NX23-NX33, . . . , NX2x-NX3x.

In some example embodiments, a path transistor P1 may be connected between a first node N61 and a second node N62 (a first connection node). A first transistor NX21 may be connected between a second node N62 and a third node N63, a second transistor NX22 may be connected between a second node N62 and a fourth node N64, and a third transistor NX23 may be connected between a second node N62 and a fifth node N65. The fourth transistor NX31 may be connected between the third node N63 and the sixth node N66, the fifth transistor NX32 may be connected between the fourth node N64 and the sixth node N66, and the sixth transistor NX33 may be connected between the fifth node N65 and the sixth node N66. The kth transistor NX2x may be connected between the second node N62 and the kth node N6x, and the k+1th transistor NX3x may be connected between the kth node N6x and the sixth node N66.

In some example embodiments, each of the plurality of transistors NX21, NX31, NX22, NX32, NX23, NX33, . . . , NX2x, NX3x may be an N-channel Metal Oxide Semiconductor (NMOS) or a P-channel Metal Oxide Semiconductor (PMOS), but example embodiments are not limited thereto.

The plurality of inductors La, Lb, Lc, . . . , Lx may include a first inductor La, a second inductor Lb, a third inductor Lc, . . . , and a kth inductor Lx. A plurality of inductors La, Lb, Lc, . . . , Lx may be grouped into a first group 613 and a second group 615. The inductor La included in the first group 613 is connected to a charging node NC and may be connected to a battery node NB through a charge transistor Qbat. The inductors Lb, Lc, . . . , Lx included in the second group 615 may be connected (or directly connected) to the battery node NB.

A capacitor C0 may be connected between the charging node NC and the sixth node N66. The capacitor C0 may charge the voltage of the charging node NC and discharge the charged voltage through the connection terminal of the PMIC (e.g., the PMIC 250 in FIG. 2). The switching circuit 611 may charge by converting a first-level input voltage VIN into a third-level voltage VSYS, or may discharge by converting the third-level voltage VSYS into the first-level input voltage VIN.

A charge transistor Qbat may be connected between a charging node NC and a battery node NB. In some example embodiments, the charge transistor Qbat may be turned off when (or in response to) an overcurrent flows from the battery node NB to the charging node NC.

The battery 330 may be formed by a battery resistance Rsen and a battery voltage VBAT. Battery current IBAT may flow through the battery 330.

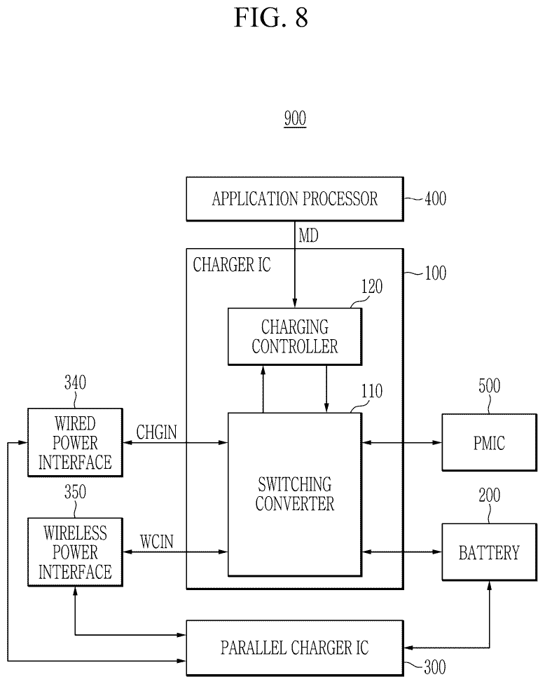

FIG. 8 is a block diagram illustrating an electronic device including a charge integrated circuit according to some example embodiments.

Referring to FIG. 8, the electronic device 900 may include a charge IC 100, a battery 200, a parallel charge IC 300, a wired power interface 340, a wireless power interface 350, and an application processor 400.

In the electronic device 900, the application processor 400 may recognize a device connected to the wired power interface 340 and the wireless power interface 350. For example, the application processor 400 may recognize a first input voltage CHGIN provided from a wired power interface 340 and a second input voltage WCIN provided from a wireless power interface 350. The application processor 400 may generate a mode signal MD that determines a switching mode depending on (or based on) a recognized interface or input voltage. The application processor 400 may provide a mode signal (MD) to the charge IC 100 or to the parallel charge IC 300. For example, the application processor 400 may provide a mode signal MD to the charge IC 100 when (or in response to) it recognizes the first input voltage CHGIN. For example, the application processor 400 may provide a mode signal MD to the parallel charge IC 300 when (or in response to) it recognizes the second input voltage WCIN.

For example, when a first input voltage CHGIN is applied through a wired power interface 340 and a wireless power transmission circuit is connected to a wireless power interface 350, the application processor 400 may recognize the first input voltage CHGIN and the wireless power transmission circuit and generate a mode signal MD indicating a buck-boost mode. In some example embodiments, when a device is connected to the wired power interface 340 or a wireless power transmission circuit is connected to the wireless power interface 350, the application processor 400 may generate a mode signal MD indicating a boost mode.

For example, when the voltage of the battery 130 is lower than the threshold voltage, the application processor 400 may generate a mode signal MD indicating a load boosting mode, and the charging controller 120 may control the switching converter 110 so that a switching operation (e.g., a load boosting operation) corresponding to the mode signal MD is performed.

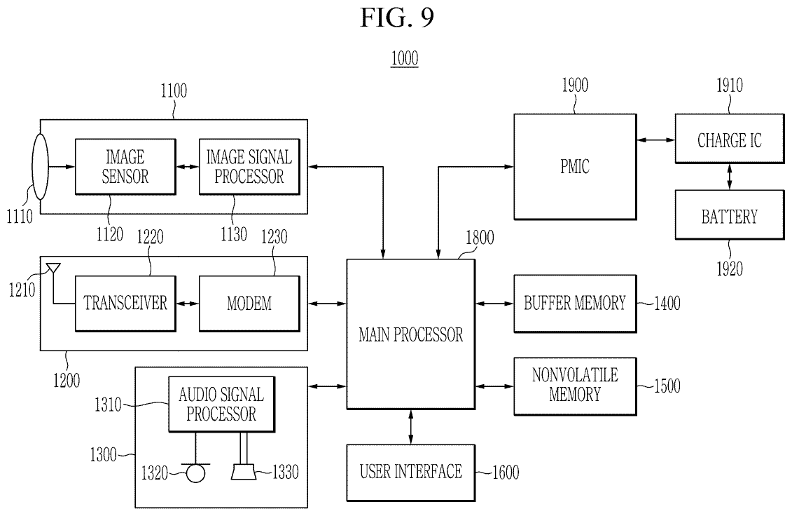

FIG. 9 is a block diagram illustrating an electronic device including a charge integrated circuit according to some example embodiments.

Referring to FIG. 9, the electronic device 1000 may include various electronic circuits. As an example, the electronic circuits of the electronic device 1000 may include an image processing block 1100 (including image processing circuitry), a communication block 1200 (including communication circuitry), an audio processing block 1300 (including audio processing circuitry), a buffer memory 1400, a nonvolatile memory 1500, a user interface 1600, a main processor 1800 (including one or more processors), a power management circuit 1900 (also referred to as PMIC 1900), and a charge IC 1910.

The electronic device 1000 may be connected to a battery 1920, and the battery 1920 may supply power used for the operation of the electronic device 1000, but example embodiments are not limited thereto. For example, the power supplied to the electronic device 1000 may be provided from an internal/external power source other than the battery 1920.

The image processing block 1100 may receive light through a lens 1110. An image sensor 1120 and an image signal processor 1130 included in the image processing block 1100 may generate image information related to an external object based on received light.

The communication block 1200 may exchange signals with an external device/system through an antenna 1210. The transceiver 1220 and MODEM (Modulator/Demodulator) 1230 of the communication block 1200 may process signals exchanged with an external device/system according to one or more of various wired/wireless communication protocols.

The audio processing block 1300 may process sound information using an audio signal processor 1310. The audio processing block 1300 may receive audio input through a microphone 1320 and output audio through a speaker 1330.

Buffer memory 1400 may store data used for the operation of the electronic device 1000. As an example, the buffer memory 1400 may store (or temporarily store) data processed or to be processed by the main processor 1800. For example, the Buffer memory 1400 may include volatile memory such as Static Random Access Memory (SRAM), Dynamic RAM (DRAM), Synchronous DRAM (SDRAM), and/or nonvolatile memory such as Phase-change RAM (PRAM), Magneto-resistive RAM (MRAM), Resistive RAM (ReRAM), Ferro-electric RAM (FRAM), but example embodiments are not limited thereto.

Nonvolatile memory 1500 may store data regardless of whether power is supplied. For example, the nonvolatile memory 1500 may include at least one of various nonvolatile memories such as flash memory, PRAM, MRAM, ReRAM, FRAM, etc. As an example, the nonvolatile memory 1500 may include removable memory such as an SD (Secure Digital) card or an SSD (Solid State Drive), and/or embedded memory such as an eMMC (Embedded Multimedia Card).

The user interface 1600 may mediate communication between a user and an electronic device 1000. As an example, the user interface 1600 may include an input interface for receiving input from a user and an output interface for providing information to the user.

The main processor 1800 may control the operations (or overall operations) of components of the electronic device 1000. The main processor 1800 may process various operations to operate the electronic device 1000. For example, the main processor 1800 may be implemented as a general-purpose processor, a special-purpose processor, an application processor, a microprocessor, etc., and may include one or more processor cores.

The power management circuit 1900 may supply (or control the supply of) power to components of the electronic device 1000 and manage the power. For example, the power management circuit 1900 may output a system voltage based on power supplied from the charge IC 1910 and/or the battery 1920. The power management circuit 1900 may control the frequency of each component, the voltage level of the provided system voltage, etc., depending on (or based on) the temperature of the components, the operation mode (e.g., performance mode, standby mode, sleep mode), etc.

The charge IC 1910 may charge the battery 1920 based on power supplied from an external power source, or supply power to the power management circuit 1900 (e.g., supply power to the management circuit 1900 from power received from the battery 1920). Additionally or alternatively, the charge IC 1910 may supply power to an external device through a wired or wireless power interface based on power supplied from the battery 1920.

The charge IC 100 described with reference to FIGS. 1 to 8 may be applied to an electronic device 1000 as a charge IC 1910. The charge IC 1910 may include a bidirectional switching converter implemented as a multi-level DC-DC converter. The bidirectional switching converter may operate in buck mode, boost mode, and load boosting mode. The bidirectional switching converter may include at least one inductor.

In buck mode, the charge IC 1910 may increase the amount of power used (or required) to charge the battery 1920 due to the current flowing through at least three inductors. While the current flowing through the first inductor passes through a charge transistor (e.g., the charge transistor Qbat in FIG. 2), the current flowing through the remaining inductors, except for the first inductor, among at least three inductors may not pass through the charge transistor. Accordingly, the charge IC 1910 may reduce power loss caused by the resistance component of the charge transistor.

In a load boosting mode, the charge IC 1910 may include at least three inductors, and may maintain power supply to the electronic device 1000 without powering off, even when a voltage of the battery 1920 is lower than a threshold voltage, through a load boosting operation.

In some example embodiments, each component or a combination of two or more components described with reference to FIGS. 1 to 9 may be implemented as a digital circuit, a programmable or non-programmable logic device or array, an application specific integrated circuit (ASIC), or the like.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FGPA), a System-on-Chip (SoC), a programmable logic unit, a microprocessor, application-specific integrated circuit (ASIC), etc.

Any or all of the elements described with reference to FIGS. 1-9 may communicate with any or all other elements described with reference to FIG. 1-9 (or with external elements not shown in FIGS. 1-9). For example, any element may engage in one-way and/or two-way and/or broadcast communication with any or all other elements in FIGS. 1-9 (or with external elements), to transfer and/or exchange and/or receive information such as but not limited to data and/or commands, in a manner such as in a serial and/or parallel manner, via a bus such as a wireless and/or a wired bus (not illustrated). The information may be in encoded in various formats, such as in an analog format and/or in a digital format.

While some example embodiments of the present inventive concepts have been described in detail above, the scope of the present inventive concepts is not limited thereto, and various modifications and alterations made by those skilled in the art based on the basic concepts of the present inventive concepts defined in the following claims are also within the scope of the present inventive concepts.

What is claimed is:

1. A charge integrated circuit comprising:
a switching converter including a switching circuit, the switching circuit including
a path transistor between a first node and a second node, the first node configured to receive an input voltage,
a first transistor between the second node and a third node,
a second transistor between the second node and a fourth node,
a third transistor between the second node and a fifth node,
a fourth transistor between the third node and a ground voltage,
a fifth transistor between the fourth node and the ground voltage, and
a sixth transistor between the fifth node and the ground voltage,
a plurality of inductors connected to the switching circuit,
a charge transistor between at least one inductor of the plurality of inductors and a battery node; and
a charging controller configured to generate a driving control signal, the driving control signal configured to control the switching circuit.

2. The charge integrated circuit of claim 1, wherein:
the plurality of inductors includes a first inductor connected to the third node, a second inductor connected to the fourth node, and a third inductor connected to the fifth node,
the first inductor is between the switching circuit and the charge transistor, and the second inductor and the third inductor are between the switching circuit and the battery node.

3. The charge integrated circuit of claim 2, wherein:
the charging controller is configured to generate the driving control signal having a first level in response to the input voltage being greater than a voltage of the battery node.

4. The charge integrated circuit of claim 3, wherein:
the charge IC is configured to perform a buck converting operation in response to the driving control signal having the first level, the buck converting operation including a period in which the path transistor, the charge transistor, the first transistor, the second transistor, and the third transistor are turned on, and the fourth transistor, the fifth transistor, and the sixth transistor are turned off.

5. The charge integrated circuit of claim 4, wherein:
the switching converter is configured to supply power to the battery node in response to the driving control signal having the first level,
to supply the power to the battery node, the switching converter is configured to
provide a first sub-path for supplying the power to the battery node through the first transistor, the first inductor, and the charge transistor, and
provide a second sub-path for supplying the power to the battery node through the second transistor and the second inductor, and the third transistor and the third inductor.

6. The charge integrated circuit of claim 2, wherein:
the charging controller is configured to generate the driving control signal having a second level in response to the input voltage being lower than a voltage of the battery node and the voltage of the battery node being below a particular level.

7. The charge integrated circuit of claim 6, wherein:
the switching converter is configured to perform load boosting operation in response to the driving control signal having the second level, the load boosting operation including
a first period in which the path transistor and the charge transistor are turned off;
a second period in which the second transistor and the third transistor are turned on, and the first transistor, the fourth transistor, the fifth transistor, and the sixth transistor are turned off; and
a third period in which the first transistor is turned on, the second transistor, the third transistor, the fourth transistor, the fifth transistor, and the sixth transistor are turned off.

8. The charge integrated circuit of claim 7, wherein:
the switching converter is configured to provide
a first path providing a stepped-up voltage from the battery node to the second node through the second transistor and the second inductor, and the third transistor and the third inductor in the second period, and
a second path supplying power from the second node to a charging node between the first inductor and the charge transistor through the first transistor and the first inductor in the third period.

9. The charge integrated circuit of claim 2, wherein:
the charging controller is configured to generate the driving control signal based on a battery current flowing through a battery connected to the battery node and a system current flowing in a power management integrated circuit connected to a charging node between the first inductor and the charge transistor.

10. An electronic device comprising:
a switching converter, the switching converter including
a path transistor between a first node and a second node, the first node configured to receive an input voltage;
a switching circuit including a plurality of transistor pairs between the second node and a ground voltage;
a plurality of inductors connected to the switching circuit and grouped into a first group and a second group; and
a charge transistor between a first inductor of the plurality of inductors included in the first group and a battery node, wherein a second inductor of the plurality of inductors included in the second group is between the switching circuit and the battery node;
a charging controller configured to generate a driving control signal, the driving control signal configured to control the switching circuit;
a battery connected to the battery node; and
a power management integrated circuit (PMIC) connected to a charging node between the first inductor included in the first group and the charge transistor.

11. The electronic device of claim 10, wherein:
the charging controller is configured to generate the driving control signal having a first level in response to the input voltage being greater than a voltage of the battery node.

12. The electronic device of claim 11, wherein:
the switching converter is configured to supply power to the battery node in response to the driving control signal having the first level,
to supply the power to the battery node, the switching converter is configured to
provide a first sub-path for supplying the power to the battery node through the first inductor included in the first group and the charge transistor, and
provide a second sub-path for supplying the power to the battery node through the second inductor included in the second group.

13. The electronic device of claim 10, wherein:
the charging controller is configured to generate the driving control signal having a second level in response to the input voltage being lower than a voltage of the battery node and the voltage of the battery node being below a particular level.

14. The electronic device of claim 13, wherein the switching converter is configured to provide
a first path providing a stepped-up voltage from the battery node to the second node through the second inductor included in the second group; and
a second path supplying power from the second node to the charging node through the first inductor included in the first group.

15. The electronic device of claim 10, wherein:
a number of inductors of the plurality of inductors included in the first group is less than a number of inductors of the plurality of inductors included in the second group.

16. The electronic device of claim 10, wherein the switching circuit includes
a first transistor between the second node and a third node, a second transistor between the second node and a fourth node, a third transistor between the second node and a fifth node, a fourth transistor between the third node and the ground voltage, a fifth transistor between the fourth node and the ground voltage, and a sixth transistor between the fifth node and the ground voltage.

17. The electronic device of claim 10, wherein:
the charging controller is configured to generate the driving control signal based on a battery current flowing in the battery and a system current flowing in the PMIC.

18. A charge integrated circuit (IC) including:
a path transistor between a first node and a second node, the first node configured to receive an input voltage;
a first transistor between the second node and a third node;
a second transistor between the second node and a fourth node;
a third transistor between the second node and a fifth node;
a fourth transistor between the third node and a ground voltage;
a fifth transistor between the fourth node and the ground voltage;
a sixth transistor between the fifth node and the ground voltage;
a charge transistor between the third node and a battery node;
a first inductor between the third node and the charge transistor;
a second inductor between the fourth node and the battery node; and
a third inductor between the fifth node and the battery node.

19. The charge integrated circuit (IC) of claim 18, wherein:
the charge integrated circuit (IC) is configured to perform a buck converting operation in response to the input voltage being greater than a voltage of the battery node, the buck converting operation including a period in which the path transistor, the charge transistor, the first transistor, the second transistor, and the third transistor are turned on, and the fourth transistor, the fifth transistor, and the sixth transistor are turned off.

20. The charge integrated circuit (IC) of claim 18, wherein:
the charge integrated circuit (IC) is configured to perform load boosting operation in response to the input voltage being lower than a voltage of the battery node and the voltage of the battery node being below a particular level, the load boosting operation including
a first period in which the path transistor and the charge transistor are turned off;
a second period in which the second transistor and the third transistor are turned on, and the first transistor, the fourth transistor, the fifth transistor, and the sixth transistor are turned off; and
a third period in which the first transistor is turned on, the second transistor, the third transistor, the fourth transistor, the fifth transistor, and the sixth transistor are turned off.
